(19) United States
(12) Patent Application Publication
(10) Pub. No.: US 2007/0100660 A1
(43) Pub. Date: May 3, 2007

(54) Electronic physician's order entering system

(75) Inventors: Kevin Vern Carosso, Santa Cruz, CA (US); David Lyon Kashtan, Santa Cruz, CA (US); Hillel Isaac Kashtan, Santa Cruz, CA (US); Eliot Marvin Rubinov, Santa Cruz, CA (US)

Correspondence Address: Crockett & Crockett;Suite 400, 24012 Calle De La Plata, Laguna Hills, CA, 92653, US

(73) Assignee: Validus Medical Systems, Inc.

(21) Appl. No.: 11/262,180

(22) Filed: Oct. 28, 2005

(51) Int. Cl. G06Q 10/00; G06F 3/00

(52) U.S. Cl. 705/2; 715/764

(57) ABSTRACT

An electronic physician's orders system that automates and simplifies existing methods of generating, maintaining and retrieving physician's orders. In contrast to other systems, the electronic physician's orders system can create physician's orders electronically at the point-of-care and can maintain the orders in an Orders' Database or print the orders for use in a paper-based system. Thus, the system can eliminate or supplement creating and maintaining handwritten physician's orders records.

### FIELD OF THE INVENTIONS

The inventions described below relate to the field of electronic medical records and more specifically, relate to generating electronic physician's orders.

### BACKGROUND OF THE INVENTIONS

The process of communicating directions or instructions from a physician to other healthcare professionals is critically important in the practice of medicine. Traditionally, physicians generate orders by writing an order in a chart for hospitalized patients or by writing a prescription on a prescription blank for outpatients. The physician typically relies on personal knowledge supplemented by available reference sources (e.g., books, journals, professional consultations, etc.) together with an in depth understanding of the patient's medical condition when formulating a therapeutic regimen and ordering the appropriate diagnostic testing, medications, or ancillary services.

Current handheld computer systems such as personal digital assistants (PDAS) show promise in improving the process of generating physician's orders. For example, a drug order or prescription could be entered directly into a PDA and transmitted electronically thereby reducing the time from when the order is generated to when it is received in the pharmacy. Numerous systems have been developed that focus on order entry.

Generally, there are two types of electronic medical record computer systems. The first type is a “stand-alone” system. This is an independent computer system that regulates all of the operational tasks such as medication dispensing, billing, inventory, etc. Typically, two separate hospital departments interface the “stand-alone” system. One department oversees patient admissions, transfers and discharges (ADT) and the other department accepts billing and financial transactions.

The second type of electronic medical record computer systems, the “total hospital system”, is functionally similar to the “stand-alone” system but has been incorporated into a computer network that interconnects all departments of the hospital. Each department (e.g., laboratory, radiology, pharmacy, medical records) is accessible from computers located throughout the hospital.

With “stand-alone” systems physician's orders processing begins with the delivery of written or faxed orders to an appropriate department within the hospital such as the laboratory or pharmacy. Inefficiencies such as illegibility, unnecessary paperwork and task duplication exist in the handling and delivery process. Furthermore, problems with physician's orders are not quickly resolved because of delays involved from when the order was written, received by the appropriate department, and recognized by the related healthcare professional.

“Total hospital systems” attempt to improve the efficiency of the ordering process by transferring the responsibility for entering orders into the computer system to the physicians. For example, these orders may include medications, laboratory tests, diets, etc. In these systems, the physician enters the orders directly from computer workstations. The result is a reduction in paperwork and task duplication. However, a number of problems remain. Computer order entry inefficiencies exist due to slow and cumbersome ordering pathways. Typically, these pathways were not developed by medical professionals and are difficult to follow.

Furthermore, existing computerized physician's orders entry systems do not solve other inefficiencies in the order entry process. Relevant patient information is often not readily available to the physician in a complete, comprehensive and organized format. This includes lists of current and past physician's orders, height, weight, and age, and information on drug allergies and adverse drug reactions. This information is important when making medical decisions. Similarly, present systems often do not keep physicians informed of formulary information and drug availability, and of policies regarding hospital prescribing guidelines and restrictions. For example, prescribing information with respect to clinical practice guidelines, Medicaid restrictions, multi-disciplinary action plans (MAP's), clinical practice standards or clinical pathways all need to be communicated to the prescriber in an effective manner. Additional shortcomings in existing systems include the need for providing the prescriber with updated laboratory data and new procedures. Finally, in paper-based medical records and order systems, handwritten order are sometimes difficult to read due to poor handwriting skills of the prescriber.

Because of these limitations in existing medical record and physician's order systems, it would be desirable to provide a computerized physician order entry system that overcomes these inefficiencies and shortcomings.

### Summary

The electronic physician's orders system automates and simplifies existing methods of generating, maintaining and retrieving physician's orders. In contrast to other systems, the electronic physician's orders system can create physician's orders electronically at the point-of-care and can maintain the orders in an orders' database or print the orders out for use in a paper-based system. Thus, the system can eliminate or supplement creating and maintaining physical physician's orders records. The electronic physician's orders system furnishes healthcare providers with an intuitive, easy-to-use, graphical user interface and speech recognition system that enables healthcare providers to generate, review, and implement physician's orders quickly and efficiently. Using the electronic physician's orders system, physicians or other healthcare professionals can enter orders for patients immediately at the point of care.

The electronic physician's orders system allows physicians to generate instructions or directions, physician's orders, for items such as laboratory procedures, diagnostic procedures, medications, nutritional services, medical equipment, precautions, psychological services, transfers, discharges, consultations, and ancillary services. The unique graphical user interface of the electronic physician's orders systems prevents health professionals from making errors in orders for patients and assures orders are clear, concise and thoroughly completed. The electronic physician's orders system fits into existing workflows at health care providers by also using existing paper order page systems that utilize order pages for communicating and documenting orders

The electronic physician's orders system provides for drafting physician's orders for a patient at the point-of-care. Instant access to a patient's electronic medical record by authorized healthcare providers from any geographical location may also be provided. Thus, the electronic physician's orders system enables authorized healthcare providers to access and update patient files using wireless personal computers. To enable an improved orders' system, the electronic physician's orders system permits healthcare providers, such as physicians or nurse practitioners, to electronically annotate patient data and prepare orders. Thus, a healthcare provider can acknowledge reviewing patient data, provide instructions, such as prescriptions for medication to administer to a patient, and approve recommendations for treatment by other providers, all by electronically annotating a patient's record or by preparing an order electronically and printing it off for use in paper-based legacy systems. In addition, authorized healthcare providers can access a record while other providers use the same record allowing for real-time collaboration. The availability of electronic data permits instant, sophisticated analysis of patient data.

### BRIEF DESCRIPTION OF THE DRAWINGS

FIG. 1 illustrates a prior art physician's order.

FIG. 2 illustrates a diagram of the electronic physician's orders system.

FIG. 3 illustrates the graphical user interface from the mobile platform software displaying an order set on the mobile platform hardware

FIG. 4 illustrates the routing of the electronic orders in the electronic physician's orders system

FIG. 5 shows a printed output of an order.

FIG. 6 illustrates a highlighted field that may be filled using speech input.

FIG. 7 illustrates an initial login screen of the electronic physician's orders system.

FIG. 8 illustrates the workflow of the electronic physician's orders system.

### DETAILED DESCRIPTION OF THE INVENTIONS

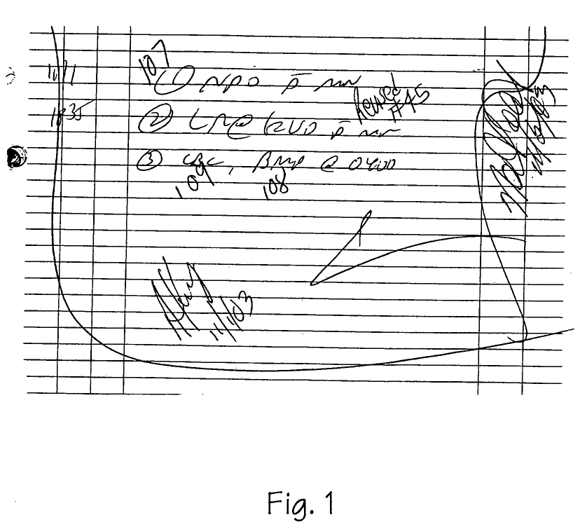

FIG. 1 illustrates a typical prior art physician's order. Traditionally, physicians generate orders by writing an order in a chart for hospitalized patients or by writing a prescription on a prescription blank for outpatients. Physician's orders are often difficult to read making their implementation by hospital staff onerous.

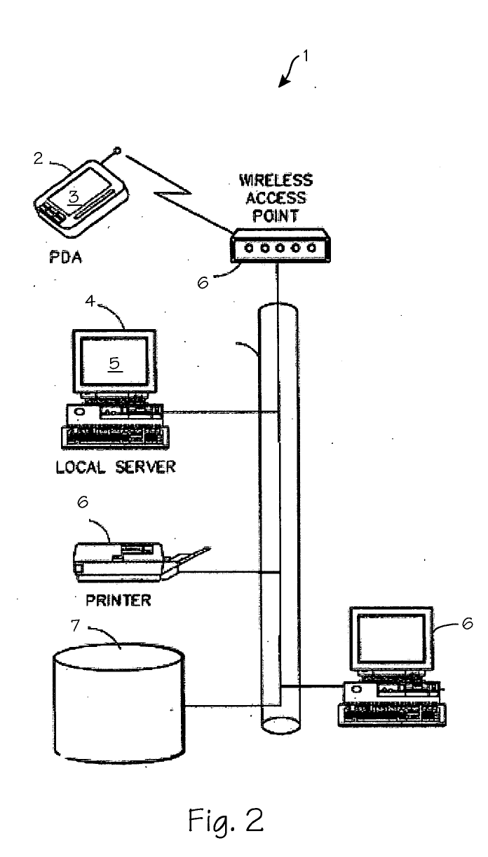

FIG. 2 illustrates a diagram of the electronic physician's orders system 1. Areas of functionality directly addressed by the electronic physician's orders system include Patient Selection and Location, Review of Patient Data, Access to Patient Data During Patient Examination, Writing and Signing Progress Notes, Writing Orders, Validating Orders, Signing Orders, and Communicating Orders to various departments. The electronic physician's orders system comprises a mobile platform 2 such as a personal digital assistant, mobile platform software 3, a server hardware platform 4, server platform software 5, and infrastructure hardware 6 such as wireless routers, personal computers and printers and infrastructure software 7. The workflow and data communication of the electronic physician's orders system between its components include using order submission, virtual inboxes, order distribution and filtering, and hard copies of electronic physician's orders.

The electronic physician's orders system enables the Charge Nurse or Unit Clerk to dispatch orders, contact ancillary department personnel, process Orders, provide orders to other nursing staff, administer care, and record verbal orders. Further, the electronic physician's orders system improves communication by storing and forwarding information. Communication of order submissions is provided for dispatch or for signature. Communication as part of order processing or administering of care is improved and the communication of clinical results and other data is provided back to physicians. The electronic physician's orders system also provides for real-time communication between healthcare professionals. Communication of notifications and alerts can be sent out within the system. In addition, requests and results from consultations from other healthcare providers is also provided.

One focus of the electronic physician's orders system is related to the mechanics of entering orders, as opposed to the clinical assessment process that goes into deciding what orders to make. The electronic physician's orders system addresses ease of order entry, clarity of orders, legibility of orders, and timely communication of physicians' orders. Access may optionally be provided to clinical data such as lab results or vital signs. The system may also provide validation of orders for allergy interactions or dosing.

Another focus of the electronic physician's orders system is to reduce the need for pharmacy calls back to the physician. The pharmacy, however, can remain as final line of defense against adverse drug events. The electronic physician's orders system can work within paper chart systems currently found within the clinical workflow of health care providers. Paper chart systems rely on paper charts for clinical information and to maintain records of orders entered.

The electronic physician's orders system addresses Human-readable representation of order submissions. Direct data inter-working with downstream systems may be incorporated with the electronic physician's orders system. The electronic physician's orders system provides orders available on-screen for transcoding and other action. Printed versions of these orders' submissions continue to play a key role and replace hand-written orders in the chart.

The electronic physician's orders system supports patient selection and patient list management for the physician. Physically locating the patient within the healthcare provider can also be accomplished by the system. The electronic physician's orders system is able to accommodate physician's order entry by generating new orders, structured orders that are menu driven, free text orders, and order sets. The electronic physician's orders system makes it easy for physicians to follow protocols and make modifications to already submitted orders and existing orders. These modifications include discontinuing, canceling, renewing, changing, and validating orders. Order signing and co-signing are also facilitated by the electronic physician's orders system.

Order submission is the creation of a collection of one or more orders entered by a single user for a single patient. Order distribution and filtering is the mechanism by which the right order submissions get to the right destinations. Hardcopies include printed order-pages, order worksheets and other printed hardcopies.

An electronic physician order submission includes a collection of one or more authorized electronic orders entered by a single user for a single patient awaiting processing. The electronic order may be saved prior to submission when a user has saved the order submission for future editing and/or actual submission. An order may be authorized and submitted for processing. In this case an authorized user has signed off on the order and submitted it to the appropriate medical department or personnel so the order instructions may be carried out. An order may be routed for authorization in the situation where an unauthorized user has completed order submission and forwarded it for authorization. Electronic physician order sets or templates comprise information such as an Order submission ID which is unique identifier based on Patient ID, Physician ID, and date/time order; patient ID number; date and time of the order; a physician ID and relationship to the patient; status of the order; order type; order instructions; order parameters; and order destination.

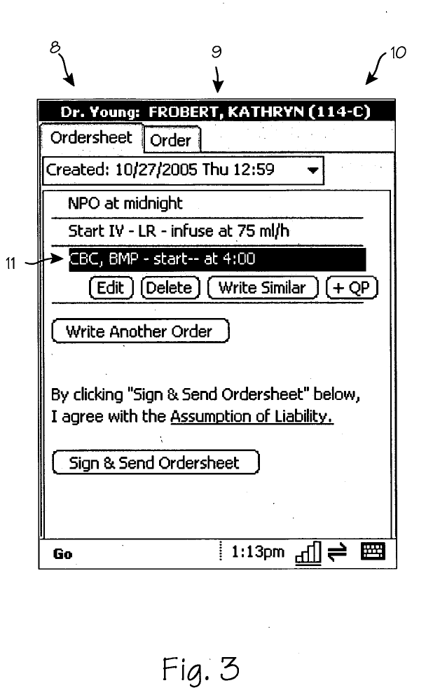

FIG. 3 illustrates the graphical user interface from the mobile platform software displaying an order set on the mobile platform hardware. In the Physician ID field 8, the current authorized user is indicated to be Dr. Jennifer Young. The Patient name ID field 9 displays the patient for which the electronic orders will be submitted. Here, the name of the patient is Kathryn Fobert. The Patient location field 10 displays the patient ID of 114-C. The GUI also lists a set of orders 11 displaying the order types ready for submission.

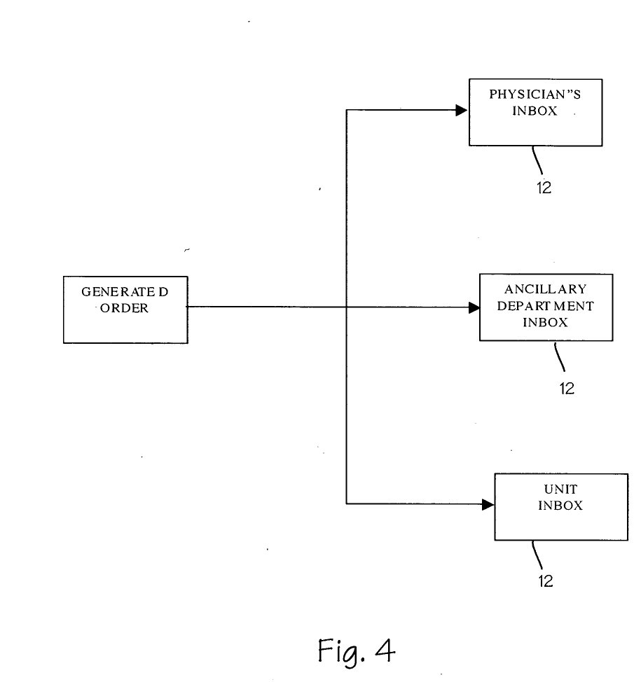

FIG. 4 illustrates the routing of the electronic orders in the electronic physician's orders system using the server. The virtual inboxes 12 used in the server software are the means by which order submissions are received by different players in the workflow. The types of inboxes found in the electronic physician's orders system may include a unit inbox, ancillary department inbox and physician inbox. A unit inbox is assigned on the server to each unit or ward using the electronic physician's orders system. Authorized orders arrive in the inbox and are dispatched and processed by the appropriate medical personnel in the respective unit. An ancillary department inbox may be assigned to each ancillary department using the electronic physician's orders system that process orders directly. Authorized orders arrive in the inbox directly from a source for processing by destination. A physician inbox is assigned one inbox per authorized physician. Draft orders may be sent to the physician's inbox from unauthorized sources (e.g. students) requiring authorization for submission.

The orders generated using the electronic physician's orders system are filtered and distributed appropriately. The electronic physician's orders server and mobile platform software defines a set of order types. Every order made is assigned to a particular type. Order types may include Pharmacy Orders, Nursing Orders, Dietary Orders and Therapy Orders. Each unit or ancillary department inbox may be configured to control which order submissions it receives and how they are rendered for processing. Control over order subscription may be based on several criteria including by unit or order type. A unit inbox may subscribe to receive order submissions for any patients associated with one or more specific units in a medical facility. Orders may also be distributed by order type. Units, ancillary departments or individual users may subscribe to received order submissions that contain at least one order of a specific type or set of types such as pharmacy orders, nurses orders, dietary orders or therapy orders.

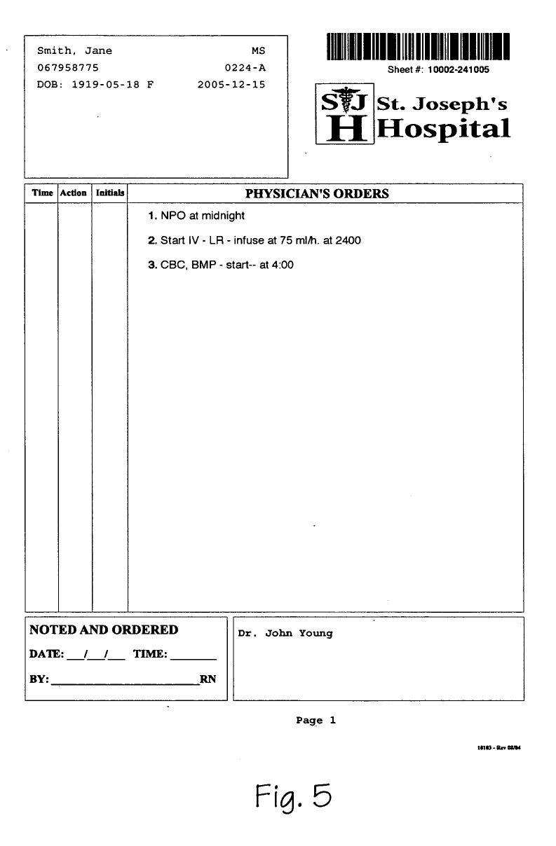

The electronic physician's orders system uses a variety of outputs for order processing. On-screen electronic notification and electronic presentation of orders for processing is provided. Order Submissions can be rendered as order pages for printout and physical placement in the patient's chart. Order Worksheets for dispatching by charge a nurse or unit clerk or for processing by destination department may also be generated. The printed output of an order, as shown in FIG. 5, also serves an important purpose in electronic physician's orders system. Printouts of order submission may replace hand-written orders and order set pages that normally appear in the chart. The easy to read printed documents from the electronic physician's orders system improve workflow in paper-based healthcare systems.

The mobile platform is a mobile handheld computer device, such as a PDA, with wireless electronic data transmission and reception capabilities. The wireless transmission of data may be accomplished through radio frequency and supported by standards such as IEEE 802.11 or BlueTooth®. The mobile platform is used for Physician Order Entry and may be provided with security restrictions for use within a hospital setting having wireless data access.

Use of the PDA within the electronic physician's orders system is advantageous because the PDA is mobile and fits within a lab-coat pocket. The mobile platform should have a display with a minimum of 240×320 pixels resolution and 16-bit color palette. In addition, the mobile platform should contain audio input and output capabilities. Controls such as a touch-screen, buttons, and one-handed push to talk should also be provided. Further, the handheld device should contain a removable media slot for application and data storage as well as a removable, replaceable and rechargeable battery.

The mobile platform software for use with the electronic physician's orders system is compatible with existing operating systems such as Palm™ OS and Pocket PC™. The mobile platform software is operable from removable media such as a flash memory card in the mobile device. The mobile platform software facilitates the menu-based physician's order generation. Alternatively, the mobile platform may operate in a thin client setting with the software applications residing on a server. A unique multi-modal user interface is provided to the mobile platform. The multi-modal user interface comprises both a graphical user interface and speech input through speech recognition. The primary modality is graphical user interface. All tasks can be completed through its use. Speech input is used as an accelerator for interactions that could otherwise be completed using the GUI. The primary modes of the GUI interaction are visual interaction methods such as menus, checkboxes, links, etc. and typically require the use of a stylus. Soft small-button alphanumeric keyboard for text entry may also be used. Use of a soft large-button numeric keypad can be used to enable the use a finger as an alternative to a stylus

The speech input has a push to talk interface with single-handed operation. A user would push an interface at the start of speech and release at end of speech. The speech input has built-in compensation for timing mismatch between the onset and the end of speech and button pressing and releasing. It also contains Speaker-independent recognition so no training is required. Visual feedback may also be provided to the user to indicate which graphical field(s) is (are) currently in “speech focus” and capable of being recognized. The visual feedback can also indicate whether or not speech input is enabled, and if so, whether or not it is in progress. The interface will also provide a message to indicate speech was not recognized.

A user of the system will always know when speech input is allowable and in what context including the type of phrase that would be understood by the system. Visual design of the user interface provides either explicit or implicit guidance in what to say by the user and how to say it. Some examples of this guidance in the system include consistency between visual labels and grammar; highlighting of keywords; syntax implied by layout of fields and words joining them (e.g. ______ solution with ______ meq KCl at ______ cc per hour). An order field may be highlighted with different font, colors, or speech graphic that indicates to the user that the field may be completed by using spoken commands. Sounds may also be used in conjunction with alerts if appropriate. The user interface is sensitive to a new users of the system. If this is the first login (i.e. none has yet occurred on either a mobile device or the desktop), the user is asked to change PINs. If this is the first login onto mobile device the user is offered some key introductory information about use of mobile device (e.g. how to use speech). A user is offered the opportunity to be walked through some quick setup that will facilitate early use.

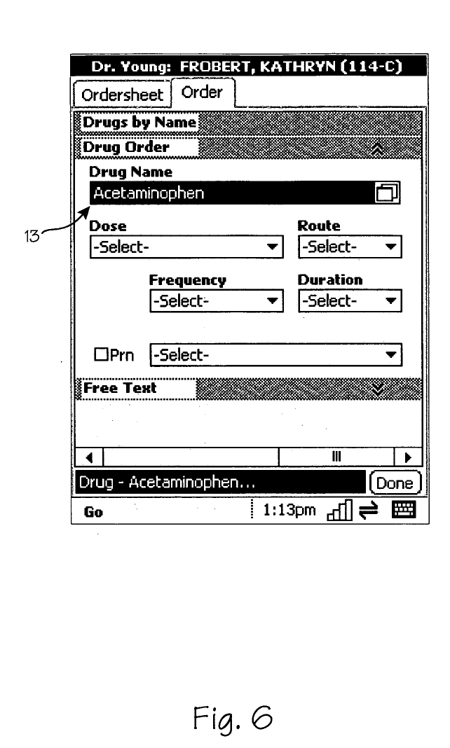

As illustrated in FIG. 6, the GUI highlights a field that may be completed using speech input. In this case, the drug name field 13 is visually differentiated from the rest of the GUI to indicate the user may select from the variety of choices available using a speech input.

The server platform hardware typically found in the electronic physician's orders system comprises a rack of standard components making up application servers. The server platform hardware is a computer on a LAN that provides services or resources to the mobile hardware platform by sharing its resources. The server platform hardware may be dedicated, in which case it shares its resources but doesn't use them themselves, except in performing administrative tasks. The server platform hardware may also be in a client/server database relationship and make database resources available to the mobile platforms. These resources may include electronic medical records for patients. Alternatively, the Servers may also be used to run applications for users, in which case the server is called an application server. The server platform software uses common, off the shelf server operating systems in addition to electronic physician's orders system supporting software. Typically, identical OS installation is on each computer in the server platform. Ideally, open source software should be used.

The infrastructure hardware includes a device network having wireless capabilities such as 802.11b @ 11 Mbit/s. The scope of mobile device support should be facility-wide with access to the server platform hardware and software by the mobile device platform. Access to the World Wide Web and a Web Browser should also be provided. Printers and user-initiated printing of electronic physician's orders forms from Web browsers should be available. The infrastructure hardware also comprises desktop devices such as a Personal Computer used also for Electronic Physician Order Entry, Non-Physician Order Entry, and Order Dispatching and Processing. The infrastructure hardware is supported by infrastructure software. The infrastructure software includes applications such as firewalls for ensuring user security and privacy, user identification and authentication, timing out of a session, user preferences, user support, and electronic medical records access.

When in use, the mobile application software begins when the mobile device is powered up while containing the mobile application software. A user may me in an active already authenticated session of using the software. In this case, there have been no session or authentication timeouts since the device was last powered off. Here, a user picks up where they left off from the last session using the system. A user may also be in an active session requiring re-authentication of the user. A session using the mobile application software may still active, but re-authentication may be required by a user. In this case, a user re-authenticates and picks up where they left off. A new session using the software may also be started after powering up. When this occurs, a last session was terminated either through log-off or session timeout. Here, a user must go through a login sequence.

A login typically comprises identification of a user and authentication of a user. During identification a user enters an alphanumeric User ID assigned by a system administrator. The system administrator may define constraints for the user having a specific User ID. A user may enter his ID by selection from a list, use of a soft keyboard entry with a stylus, or spoken entry with continuous speech (alphanumeric sequence). The mobile application may also default to the last user who logged in. After entering a User ID, authentication is required. Here, a user enters a numeric PIN. The PIN may be entered using a numeric keypad. In order to optimize the authentication and feedback process a list of known User IDs used can be made available and during keyboard entry, use of auto-completion techniques can be implement to minimize keystrokes. These techniques may include entering of predictive text, jumping to the right location in a scroll list of User IDs as more characters are entered. For speech entry, system may make use of an n-Best list, allowing PIN match against other than top choice of recognizer. PIN matching against n-Best saves the user a step. Login to the system from a mobile platform may be disabled after a certain number of repeated failed attempt as a security measure. When this occurs, the mobile platform needs to be reset. Once logged into the mobile device application software and server platform, a user is directed to an initial screen.

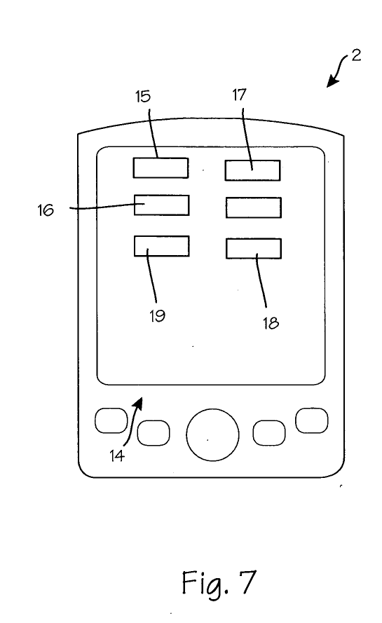

When a user logs on to the system, as shown in FIG. 7, an initial screen 14 is presented to the user on the mobile device. If there are orders that require sign-off, the initial screen provides the user with the list of orders that need to be signed off. A user can elect to proceed with sign-off of all or some orders and then go to a main screen, or skip the sign-off and go to the main screen. If there are no orders that require signing off, a user is taken directly to the main screen by the system. The main screen offers access to several functions including: Creating new orders 15, modifying existing orders 16, selecting patients 17, listing patients 18, signing off from the system 19, Retrieving a draft order if any have been saved, viewing preferences, changing a PIN.

A patient list viewing provides an entry for each patient with whom a user/physician has a relationship. It can be ordered by name or location, depending on the physician's preference. Each entry provides a patient summary including a name, location, relationship, attending staff, and consulting staff. An ability to view more detailed information on patient is also provided by accessing electronic medical records found on the server hardware platform or accessed through the server hardware platform. This patient information may be modified or in “read only format” and may include: name, location, unit (determines where authorized order submissions get routed), attending physician, date of birth/age, gender, allergies, medications, fact sheet info (to extent present in ADT), diagnostic information, treatment information and medical history. The patient listing provides for the ability to place orders for the patient and the ability to access any patient in a medical facility. Once a patient is accessed by a medical professional/user physician order entry for that patient can be made.

The patient list also allows a user to create a new patient (“virtual patient), for purposes of pre-entry of orders for patients not yet in the system. This involves creating a tag, by which that patient will subsequently appear on the patient list with a special indicator. Orders for this patient can be saved and once the patient is in the system and is selected, the saved order can be retrieved in the context of an order being created for the selected patient.

The electronic physician's orders system including the mobile and server platform software allows for patient list management. Physician or assistants working on their behalf may make changes to patient lists. They can create and manage lists by adding patients and deleting patients. The relationship of the physician may also be defined such as being attending, consulting or other.

The electronic physician's orders system provides for the electronic entry and printing of physician orders. Entry of any kind of physician order that might be written on a paper order sheet is provided by the system. The electronic physician order entry begins with selection of a patient. A patient is selected from user's patient list or from larger pool of patients accessible from the server. A newly created patient may also be selected. Once a patient is selected by a user, the electronic physician's orders system allows orders to be entered in several ways. A user may start with a blank order submission screen and fill it out or load a saved order submission and edit it. Once an electronic physicians order entry is in progress of submission, a new order may be created from Quick Picks, structured orders or free text orders. A Quick Pick is a list of common. user issued order sets or templates and may comprise pre-defined personal orders, structured orders or free-text orders. A structured order set or template is created from hospital-wide repertoire that includes typical physician order types defined in information architecture. These structured orders may be for medications, diet, nursing, activities, IV, radiology, diagnostic exams, therapeutic regiments, etc. Use of a library of structured electronic physician order sets and templates allow the electronic physician's orders system to capture most of orders necessary for use in a healthcare environment without the need to use free text orders. The mobile platform software also provides for the creation of free-text orders. Free-text orders contain a limited number of structured form fields and allow a physician to generate non-standard instructions.

A user/physician may also create orders by modifying existing orders. The mobile platform and server platform software allows a user, at any time, to review all of his orders in current order submission status prior to being signed off. While in order submission status, electronic physician orders may be edited, deleted, and added. Once an order is complete it is then submitted for processing. If user has signing authorization, submission includes electronic signature and submission is published as an authorized order for processing by a hospital unit and any destination departments that handle orders directly from a physician. If the hospital requires a written signature before the fact, submission of an order is only received by a unit, which prints it for immediate physician signature before any processing begins. If an electronic physician's orders system user does not have signing authorization, then submission is received by one or more physicians who can sign for that user. An electronic order may be sent to multiple physician inboxes and deleted from all of them as soon as one of them signs off on the order. Partially completed electronic physician's orders may be saved on the server or mobile device as a draft order submission.

Prior to or at time of submission, each electronic physician order is assigned a unique Order ID number (unique within an active patient stay). When the Order ID number is combined to a Patient ID number and a Stay ID number, a unique Patient-Stay Order ID number is created. Each order has its Patient-Stay Order ID number printed on it. The Patient-Stay Order ID numbers can be shown in an EMR or paper chart as a convenient reference for orders that are canceled, discontinued, modified, or renewed.

Electronic physician order sets, which are a series of related orders, have pre-defined order sequences. Standard electronic physician's orders may be created by clinical electronic physician's orders system administration personnel, on behalf of hospital and departmental clinical committees. The electronic physician order sets are available from a shared electronic library or depository of standard orders found on the server platform and sorted in hierarchy defined by the hospital. Users may also create personal electronic physician order sets to meet their specific needs. This may be accomplished by the editing and personalization of a standard order set or creating of a new personal order set. Personal orders may be accessed through Quick Picks. Order sets, whether they are standard or personalized, appear as single entities, which user can enter, and then edit as a sequence of orders. For each component of an order set, a user may delete it; fill in blank fields where enabled by selection, text entry, or both (as permitted for the field); modify fields where enabled by selection, text entry, or both (as permitted for the field).

The electronic physician's orders system provides electronic physician order templates to users through the mobile device platform. Physician order templates are similar to order set, but differ in that they pertain to a single complex order such as a TPN order. Order templates are expressed like an order set with fill-in fields and values. Like an order set, rendering of an order template incorporates simple formatting. Order templates can be created by clinical electronic physician's orders system administration personnel.

The mobile platform software may be used to modify active previously submitted orders. Electronic physician's orders may be canceled, discontinued, changed or renewed if an order has a stop date. A user can enter an order review mode in which they browse through order submissions for the current stay of a patient in reverse chronological order. Each order submission is rendered in a read-only mode that enables new, cancel, discontinue, change, or renew orders to be generated for one, many, or all of the orders displayed. If a change is requested, the order is “entered” into edit mode. Regardless of whether it is a structured or free-text order, the newly created order is expressed either as “cancel”, “discontinue”, or “renew” followed by old order wording and ID or, in the case of a change, a two-order sequence consisting of “discontinue” followed by old order wording (and ID) new (modified) order the new order(s) is/are classified as being of the same type as the original order. User can select a generalized “cancel”, “discontinue”, “renew”, or “change” order and supply the order ID number appearing next to it in the chart the exact same results are achieved as from the browse and select method above

Bulk order modifications can be made by the electronic physician's orders system. Bulk changes are needed when a patient is transferred to a different unit or discharged. In this case, orders may be automatically voided and may need to be explicitly reissued as “continue” orders. The electronic physician's orders system provides selected alerts for ADE (Adverse Drug Events) associated with medication orders, drug-allergy interactions and dosing (e.g. maximum single dose, maximum daily dose, etc.). Alerts are administered at appropriate severity levels. High priority alerts interrupt work flow and require a physician to correct the anomaly immediately. Low priority alerts can be sent for alerts that do not require immediate attention. A physician can choose to ignore, flag or access the low level alert to get the details regarding its content.

Because the electronic physician's orders system has speech recognition, spoken notes by physicians can be taken. This feature allows physicians to record spoken notes sent as voice attachments to order submissions. The spoken notes feature can be used as an alternative to free text entry of specific order fields found in an order set or template. Spoken notes can also be used to supplement order sets or templates. Transcribed notes can be saved by the system as an audio file. A graphical indication and link to the audio file is presented to a user when viewing an order having a spoken note. When viewing an order electronically, a user simply selects the link and the spoken order note is played by the mobile platform.

The electronic physician's orders system sends renewal alerts from the server platform to the mobile device platform. Orders with stop dates generate alerts to physician to issue renewals. A renewal alert can appear at login informing physicians about pending renewals when they initially log in. Renewal alerts may also be sent to a user through an inbox mechanism. Renewal alerts can appear when the physician selects a patient for order entry. If there are order renewals pending, users are given access to a screen that allows them to select the orders they wish to renew.

Orders generated by the electronic physician's orders system can also be signed off electronically in the system indicating they have been approved by authorized personnel. Orders may also be signed off when completed by authorized personal. Electronic physician orders are signed-off only by an authorized physician. Situations where sign-offs may be appropriate include when orders are entered and being submitted for processing as part of standard submission process, when orders pre-entered and saved for future submission, when orders are created by medical students (or other unauthorized user) and require sign-off before submission, and when verbal orders are entered into the electronic physician's orders system. Electronic sign-off may require additional authentication. In some hospitals, electronic sign-off may not be accepted, and the physician may be required to physically sign printed order sheets. However, use of a physical written signature may complicate workflow. Orders created by others in the electronic physician's orders system that require sign off can be routed to an authorized user's inbox in the system. Once orders have been signed off, they cannot be changed. They can, however, be cancelled, discontinued, or modified by creating new orders.

When orders are entered and submitted in the electronic physician's orders system, they are routed and queued to electronic/virtual inboxes on the server platform. Authorized users having a browser-based inbox application found in the server and mobile software may subscribe to orders. Virtual electronic physician's orders inboxes are the means by which users subscribe to and access incoming order submissions. The electronic orders may be routed, filtered and queued by using a variety of different attributes found in an order set or template or a user profile. These attributes may include order type, hospital ward, hospital unit, or subscriber duties.

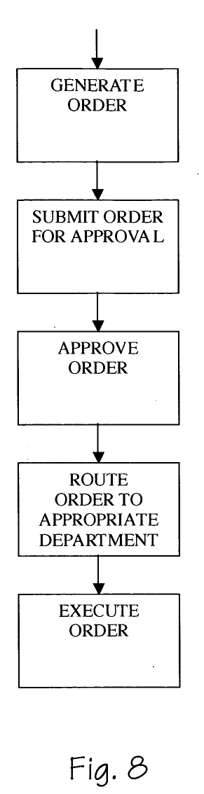

FIG. 8 illustrates the workflow of the electronic physician's orders system. An order is generated by a user with access to a mobile platform comprising the mobile platform software. Once generated, the order is submitted for approval. Approval can be performed by physically printing the order and having an authorized person sign the order. Order approval may also be approved by sending the order electronically to an inbox where an authorized individual may electronically access and approve the order. When the order is approved, the order is routed to the appropriate department to be carried out. Again, an approved order may be printed out and physically delivered to the appropriate department or alternatively, the approved order may be routed electronically using the server platform to the appropriate department. Once the order is received by the appropriate department within the health organization, it is executed.

When printing orders onto printed order sheets intended to be used with a paper-based workflow, there should be a means whereby responsible, accountable professionals can efficiently acknowledge that printed orders have been taken from the printer, read and confirmed to be clear, complete, and accurate (no printer jam, out of toner, etc errors), and confirm that the printed sheet has been properly processed into the existing paper-based workflow (usually by inserting into a patient's Chart at the Nursing Ward). A unique code disposed on each printed order sheet is used to address this issue.

The person responsible for acknowledging printed order sheets and ensuring orders enter the workflow scans the unique code using a barcode scanner or enters the unique code through a keyboard. By confirming with the code-scan as the paper sheet is handled, a “close the loop” between the clinician originating the order and the responsible person receiving the order sheets is established. Any orders which are expected to be scanned but go unscanned for some period of time will be discovered, tracked and managed. This avoids the potential for significant problems that might arise should orders go missing in a system. An order workstation having a desktop or laptop computer fitted with a printer, barcode scanner and keyboard is placed in the ward when integrating the system with paper-based workflow.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

We claim:

1. An electronic physician order entering system comprising:
a server hardware platform;
a mobile platform in wireless communication with the server hardware platform; and
a graphical user interface generated by a mobile platform software within the mobile platform capable of filling out form fields in an electronic physician order set;
wherein said graphical user interface visually indicates a form field in the electronic physician order set that may be filled by using a spoken input from a user.

2. The system of claim 1 wherein the graphical user interface provides a list of selectable physician's order templates.

3. The system of claim 1 wherein the graphical user interface displays a physician's ID field.

4. The system of claim 1 wherein the graphical user interface displays a unique order ID number.

5. The system of claim 1 wherein the server platform comprises server platform software having a plurality of virtual inboxes assigned to a plurality of ancillary departments.

6. The system of claim 1 wherein the mobile platform software allows physician order approval by an authorized user.

7. The system of claim 1 wherein the graphical user interface displays a patient location field.

8. The system of claim 1 wherein the mobile platform is capable of recording spoken notes as voice attachments and the mobile platform software is able to route the voice attachments to a virtual inbox as an order submission.

9. The system of claim 5 wherein a draft order may be sent to a physician's virtual inbox from an unauthorized source, said draft order requiring authorization for submission.

10. A method of implementing physician's orders comprising:
providing a mobile platform in wireless communication with the server hardware platform;
inputting patient data and instructions in form fields within an electronic physician order set in a graphical user interface generated by a mobile platform software within the mobile platform;
generating an electronic physician's order having a unique order ID number;
approving an electronic physician's order by an authorized user;
routing an electronic physician's order to an ancillary department virtual inbox;
printing the electronic physician's order from the ancillary department virtual inbox;
placing a printed electronic physician's order in a patient's chart within a paper-based work flow health care system; and
performing the instructions found in the electronic physician's order by the ancillary department.

11. The method of claim 10 wherein the printed electronic physician's order comprises a barcode, said bar code requiring scanning to confirm the instructions have been performed by the ancillary department.
